(19) United States
(12) Patent Application Publication
(10) Pub. No.: US 2020/0355405 A1
(43) Pub. Date: Nov. 12, 2020

(54) ELECTRIC COMPRESSOR

(71) Applicant: LG Electronics Inc., Seoul (KR)

(72) Inventors: Namsik YIM, Seoul (KR); Taekyoung KIM, Seoul (KR); Yongsoo CHO, Seoul (KR); Soonyong CHOI, Seoul (KR)

(73) Assignee: LG Electronics Inc., Seoul (KR)

(21) Appl. No.: 16/794,947

(22) Filed: Feb. 19, 2020

(30) Foreign Application Priority Data
May 9, 2019 (KR) 10-2019-0054483

(51) Int. Cl. F25B 1/00; H02K 5/08; H02K 5/22; H02K 5/24; H02K 7/14; H02K 11/33

(52) U.S. Cl. CPC F25B 1/005; H02K 5/08; H02K 11/33; H02K 5/24; H02K 7/14; H02K 5/225

(57) ABSTRACT

An electric compressor is provided, comprising a motor part comprising a stator and a rotor, an inverter electrically coupled to the motor part, a compression part coupled to the motor part, and an electrically conductive part configured to electrically connect the motor part and the inverter. The electrically conductive part comprises a support member forming a body, a terminal member, and an elastic member provided between the support member and the terminal member facing the inverter. The inverter is configured to apply a control signal to the motor part, and the compression part may be configured to rotate along a rotation of the motor part to compress refrigerant. The terminal member is inserted through and coupled to the support member and is electrically coupled to the inverter. The elastic member is compressed or stretched by vibration generated in the motor part to store a restoring force.

### CROSS-REFERENCE TO RELATED APPLICATION

This application claims the benefit of priority under 35 U.S.C. § 119(a) to Korean Patent Application No. 10-2019-0054483, filed on May 9, 2019, the disclosure of which is incorporated by reference herein in its entirety.

### BACKGROUND

### 1. Technical Field

The present disclosure relates to an electric compressor, and more particularly, to an electric compressor capable of simply implementing a motor part that generates a rotational force for compressing refrigerant and an electric connection structure between inverters that apply power to the motor part and also capable of preventing an inverter from being damaged due to vibration generated in the motor part.

### 2. Background of the Disclosure

Compressors that compress refrigerant in air conditioning systems for vehicle have been developed in various forms. In recent years, electric compressors (motor-operated compressors) driven by electric power using motors have been actively developed according to the tendency of electrification of vehicle components.

A motor-operated compressor generally employs a scroll-compression method which is suitable for a high compression ratio operation. Such a scroll-type motor-operated compressor (hereinafter, referred to as “motor-operated compressor”) includes a motor part, a compression part, and a rotating shaft connecting the motor part and the compression part.

Specifically, the motor part is configured as a rotary motor or the like, and installed inside a hermetic casing. The compression part is located on one side of the motor part, and is provided with a fixed scroll and an orbiting scroll. The rotating shaft is configured to transmit rotational force of the motor part to the compression part.

The refrigerant compressed in the compression part is exhausted to the outside of the electric compressor through an exhaust port. The exhausted refrigerant is utilized for operating an air conditioning system for vehicle.

An electric part includes a stator and a rotor. A plurality of coils are wound around the stator. Also, a magnet is provided in the rotor. The magnet provided in the rotor is generally a permanent magnet.

When power is applied to the electric part, a magnetic field is formed by the plurality of coils wound around the stator. The formed magnetic field exerts electromagnetic force on the magnet provided in the rotor. Thus, the rotor having the magnet is rotated according to the strength and direction of the electromagnetic force.

Power and a control signal for driving the electric part are applied by an inverter device. The inverter device is housed in an inverter and is electrically connected to a motor part through a busbar.

Referring to FIGS. 1 to 3, an electric compressor 1000 according to a related art is shown. An inverter element 1330 and a busbar assembly 1340 electrically connected to the inverter element 1330 are provided inside an inverter housing 1300 of the electric compressor 1000.

The electric compressor 1000 according to the related art is configured such that a connector 1600 should be electrically conductive to an electric part 1400 via a busbar assembly 1340. This is due to the absence of a separate member for connecting the inverter element 1330 to the connector 1600.

That is, as shown, a plurality of holes to be connected to the connector 1600 is formed in the busbar assembly 1340 while no separate holes are formed in the inverter element 1330. In the inverter element 1330, holes into which a plurality of pins provided in the busbar assembly are to be inserted are present.

Therefore, the busbar assembly 1340 must be provided in order for the inverter element 1330 to be electrically conductive to the electric part 1400.

However, the busbar assembly 1340 includes several electrically conductive members for electrically providing polyphase current applied to the inverter element 1330. Accordingly, the busbar assembly 1340 should typically be manufactured with a large volume, thereby increasing the size of the inverter housing 1300. As a result, the overall size of the electric compressor 1000 is increased.

On the other hand, as the size of the electric compressor 1000 decreases, the electric compressor 1000 is more easily provided in a vehicle or the like. Accordingly, in order to minimize the increase in size due to the busbar assembly 1340, an internal structure of the inverter housing 1300 is very densely formed. This makes a process of manufacturing the electric compressor 1000 more complex.

Also, it is difficult for the busbar assembly 1340 to be fully coupled to the inverter element 1330 by a method such as soldering because of structural limitations. Accordingly, it is difficult to stably maintain the electrically conductive state between the busbar assembly 1340 and the inverter element 1330, and thus a poor contact or the like may be generated.

Furthermore, when vibration is generated due to rotation of the electric part 1400, the inverter element 1330 sensitive to shock and the busbar assembly 1340 connected to the inverter element 1330 may be damaged.

However, the electric compressor 1000 according to related art has no member for preventing the generated vibration from being transferred to the inverter housing 1300 because of the narrow inner space of the inverter housing 1300. Accordingly, it is difficult to prevent the inverter element 1330 from being damaged due to the continuous operation of the electric compressor 1000.

Korean Patent No. 10-0763161 discloses a vibration reduction structure of a hermetic compressor having a corrugated pipe portion for absorbing vibration. In detail, the patent document discloses a vibration reduction structure capable of forming a portion of a pipe for connecting an accumulator and a sealed container as a corrugated pipe and thus preventing vibration generated by pressure pulsation from being transferred to the accumulator.

However, this type of vibration reduction structure can prevent the transfer of vibration between the accumulator and the sealed container, but there is a limitation in that there is no consideration about a structure for reducing vibration of an inverter housing in which the inverter element is to be housed.

Korean Patent No. 10-0867623 discloses a vibration reduction device of a compressor. In detail, the parent document discloses a vibration reduction device including a vibration absorption unit for absorbing rotational direction vibration generated when a driving motor is operated.

However, this type of vibration reduction device is for reducing rotational direction vibration, and there is a limitation in that there is no consideration about how to prevent vibration from being transferred to an inverter housing in which an inverter element is to be housed along an axial direction.

Furthermore, the above-mentioned related documents further include a limitation in that there is no consideration about an electric compressor having a structure that can easily implement electric conduction between an electric part and an inverter device.

### RELATED ART DOCUMENTS

### Patent Documents

Korean Patent No. 10-0763161 (Oct. 5, 2007)

Korean Patent No. 10-0867623 (Nov. 10, 2008)

### SUMMARY

The present disclosure is directed to providing an electric compressor having a structure capable of solving the above-mentioned problems.

First, the present disclosure is directed to providing an electric compressor having a structure capable of simplifying an electrically conductive structure between an inverter and an electric part.

Also, the present disclosure is directed to providing an electric compressor having a structure capable of preventing vibration, which is generated when an electric part is operated, from being transferred to an inverter device.

Also, the present disclosure is directed to providing an electric compressor having a structure capable of stably maintaining an electrically conductive state between an inverter and an electric part.

Also, the present disclosure is directed to providing an electric compressor having a structure capable of reducing the size of the electric compressor.

Also, the present disclosure is directed to providing an electric compressor having a structure capable of easily implementing a producing process.

Also, the present disclosure is directed to providing an electric compressor having a structure capable of simplifying an internal structure of an inverter housing in which an inverter is to be housed.

There is provided an electric compressor comprising a motor part comprising a stator and a rotor rotatably housed in the stator; an inverter electrically coupled to the motor part, the inverter being configured to apply a control signal to the motor part; a compression part coupled to the motor part and configured to rotate along with a rotation of the motor part to compress refrigerant; and an electrically conductive part configured to electrically connect the motor part and the inverter. The electrically conductive part may comprise a support member forming a body; a terminal member extending lengthwise, wherein the terminal member is inserted through and coupled to the support member, and wherein the terminal member is electrically coupled to the inverter; and an elastic member provided between the support member and the terminal member facing the inverter, wherein the elastic member is compressed or stretched by vibration generated in the motor part to store a restoring force.

Also, the terminal member of the electric compressor may comprise an input terminal located in a direction facing the inverter, and an output terminal located in a direction opposite to the input terminal and facing the motor part, wherein the output terminal is electrically coupled to the motor part.

Also, the input terminal and the output terminal of the electric compressor may be electrically coupled to each other.

Also, the electrically conductive part of the electric compressor may comprise a connection member inserted through and coupled to the support member, and to the connection member may be configured to surround a part of the terminal member adjacent to the support member.

Also, the elastic member of the electric compressor may comprise a coil spring having a hollow portion formed therein, and the terminal member may be inserted through and coupled to the hollow portion.

Also, the inverter of the electric compressor may comprise an inverter housing forming an external side facing the motor part; and an inverter cover located on another side of the inverter housing opposite to the motor part. The inverter cover may be coupled to the inverter housing and configured to form an inverter chamber therein. The inverter may also comprise a printed circuit board housed in the inverter chamber.

Also, the printed circuit board of the electric compressor may comprise an input terminal housing part formed through the printed circuit board and configured such that the input terminal is inserted to the input terminal housing part; and an input terminal connection part provided in the input terminal housing part. The input terminal connection part may be brought in electrically conductive contact with the input terminal.

Also, the inverter housing of the electric compressor may comprise a support member insertion hole recessed a predetermined distance from one surface facing the motor part, and the support member may be configured to be inserted in the support member insertion hole.

Also, the inverter housing of the electric compressor may comprise an input terminal insertion hole formed through one surface facing the motor part, and the input terminal may be configured to be inserted through and coupled to the input terminal insertion hole.

Also, when the electrically conductive part and the inverter of the electric compressor are coupled to each other, the input terminal may be inserted through and coupled to the input terminal insertion hole and may be inserted into and coupled to the input terminal housing part such that the input terminal is in electrically conductive contact with the input terminal connection part.

Also, the motor part of the electric compressor may comprise an output terminal housing part located on one side of the motor part facing the inverter, and the motor part may be configured to be inserted into, coupled to, and electrically connected to the output terminal.

Also, the elastic member of the electric compressor may be formed of two or more different materials along a length direction thereof.

Also, one side of the electric compressor in the length direction of the elastic member adjacent to the support member may be formed of a copper-nickel (Cu—Ni) alloy material, and another side opposite to the one side in the length direction of the elastic member maybe formed of an iron-nickel (Fe—Ni) alloy material.

Also, the terminal member of the electric compressor may be formed of an iron-nickel alloy material.

Also, the terminal member of the electric compressor may be formed of a ceramic material.

### Advantageous Effects

According to the present disclosure, the following effects can be achieved.

First, an inverter and a motor part may be connected to each other by an electrically conductive part. The electrically conductive part may be inserted into and coupled to an output terminal housing part of the motor part and thus may be electrically connected to the motor part. Also, the electrically conductive part may be inserted into and coupled to an input terminal housing part of the inverter and may be electrically connected to an input terminal connection part.

Accordingly, the inverter and the motor part may be electrically conductive to each other only by inserting and coupling the electrically conductive part into and to the inverter and the motor part. As a result, a complicated wiring structure for electrical conduction between the inverter and the motor part may not be required.

Also, an elastic motor may be provided on one side of the electrically conductive part facing the inverter. The elastic member may be compressed or stretched by vibration generated when the motor part is operated.

Accordingly, although the vibration may be generated due to the operation of the motor part, the generated vibration may be damped by the elastic member. As a result, the vibration generated by the motor part may not be transferred to the inverter.

Also, the electrically conductive part may be inserted into and coupled to the motor part and the inverter. Accordingly, a wiring structure for electrically connecting the electrically conductive part to the motor part and the inverter may not be required.

Accordingly, a separate fastening member for maintaining a state in which the wiring is connected to the motor part and the inverter may not be required. Furthermore, a terminal member of the electrically conductive part may be coupled to the input terminal connection part of the inverter by a method such as soldering. As a result, the electrically conductive state between the inverter, the electrically conductive part, and the motor part may be stably maintained.

Furthermore, there may be no need for a process for connecting and fastening the wiring to inverter and the motor part. Accordingly, it may be possible to simplify a process of producing the electric compressor.

Also, the input terminal of the electrically conductive part may be brought into direct contact with a printed circuit board of the inverter.

Accordingly, a busbar assembly having a complicated structure for electrically connecting the electrically conductive part to the printed circuit board and the inverter may not be required. As a result, there may be no need for a space for housing the busbar assembly in the inverter, and thus it may be possible to miniaturize the electric compressor by decreasing the size of the inverter.

Furthermore, in order to form a space for housing the busbar assembly, there may be no need to complicate the internal structure of the inverter.

Accordingly, it may be possible to simplify the structure of the inverter chamber inside the inverter as well as to decrease the size of the inverter.

### BRIEF DESCRIPTION OF THE DRAWINGS

FIG. 1 is an exploded perspective view of an electric compressor according to a related art.

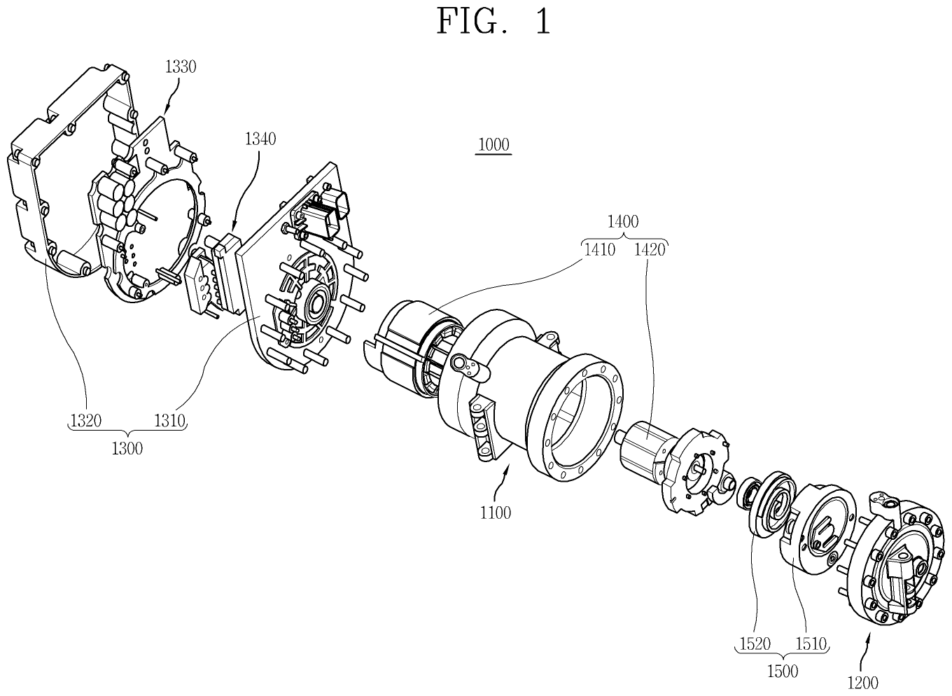

FIG. 2 is an exploded perspective view showing a coupling relationship of an inverter of the electric compressor of FIG. 1.

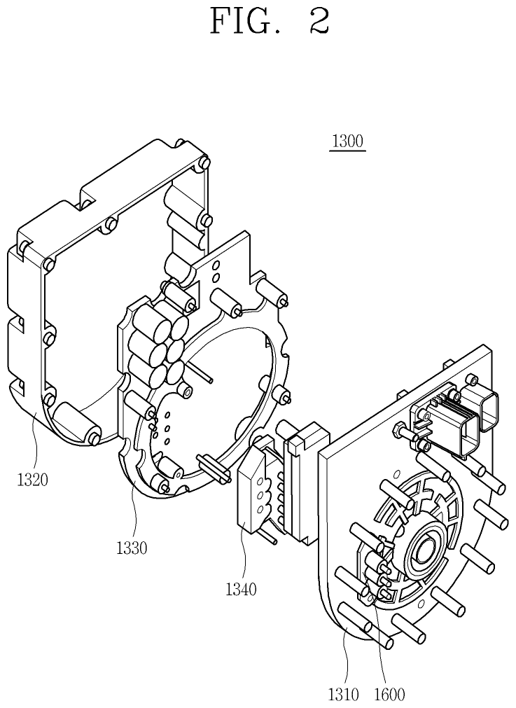

FIG. 3 is an exploded perspective view showing a coupling relationship of the inverter of FIG. 2.

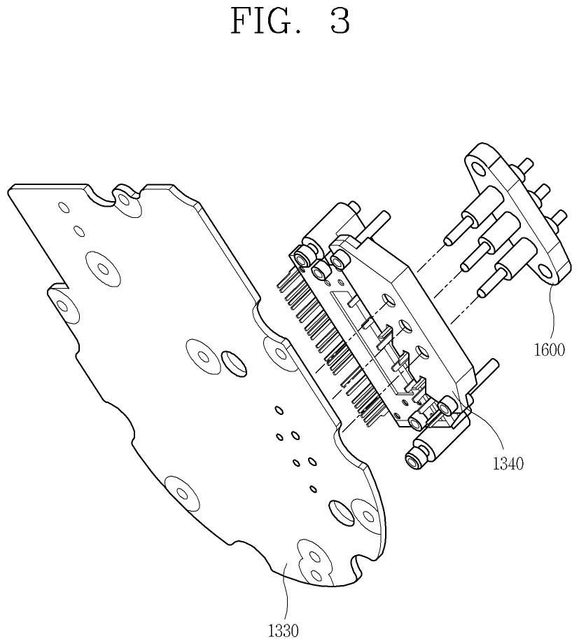

FIG. 4 is a perspective view of an electric compressor according to an embodiment of the present disclosure.

FIG. 5 is an exploded perspective view showing an internal configuration of the electric compressor of FIG. 4 according to an embodiment of the present disclosure.

FIG. 6 is a cross-sectional view of the electric compressor of FIG. 4 according to an embodiment of the present disclosure.

FIG. 7 is an exploded perspective view showing a coupling relationship of an inverter of the electric compressor of FIG. 4 according to an embodiment of the present disclosure.

FIG. 8 is a perspective view showing an electrically conductive member configured to electrically connect a motor part and the inverter of FIG. 7 according to an embodiment of the present disclosure.

FIG. 9 is a perspective view showing a connection relationship between a printed circuit board of the inverter and the electrically conductive member of FIG. 8 according to an embodiment of the present disclosure.

FIG. 10 is a plan view showing a connection relationship between the printed circuit board of the inverter and the electrically conductive member of FIG. 8 according to an embodiment of the present disclosure.

FIG. 11 is a perspective view showing a connection relationship between the motor part and the electrically conductive member of FIG. 8 according to an embodiment of the present disclosure.

FIG. 12 is a side view illustrating a state in which an elastic member is compressed by vibration generated when the electric compressor of FIG. 4 is operated according to an embodiment of the present disclosure.

FIG. 13 is a side view illustrating a state in which, based on the state of FIG. 12, the elastic member is stretched and thus the vibration is damped according to an embodiment of the present disclosure.

### DETAILED DESCRIPTION

An electric compressor 10 according to an embodiment of the present disclosure will be described below in detail with respect to the accompanying drawings.

Hereinafter, in order to clarify the technical features of the present disclosure, the description of some elements may be omitted.

It will be understood that when an element is referred to as being “connected with” another element, the element can be connected with the another element, or intervening elements may also be present.

In contrast, when an element is referred to as being “directly connected with” another element, there are no intervening elements present.

A singular representation may include a plural representation unless it represents a definitely different meaning from the context.

The term “conductive material” as used herein refers to a material capable of receiving heat or electricity from another member and transfer heat or electricity to another member. In an embodiment, the conductive material may include iron (Fe), copper (Cu), and the like.

The term “printed circuit board” (PCB) as used herein refers to a substrate for forming an electronic circuit by fixing electronic components such as an integrated circuit, a resistor, and a condenser to a surface of a printed wiring board and by connecting the components by means of wiring or the like.

The term “inverter device” as used herein refers to an electronic circuit element using semiconductor. In an embodiment, the inverter device may be provided as a switching element.

In an embodiment, an inverter element may refer to a component or device that is provided as a switching element to have a function of opening or closing a circuit without using contact points.

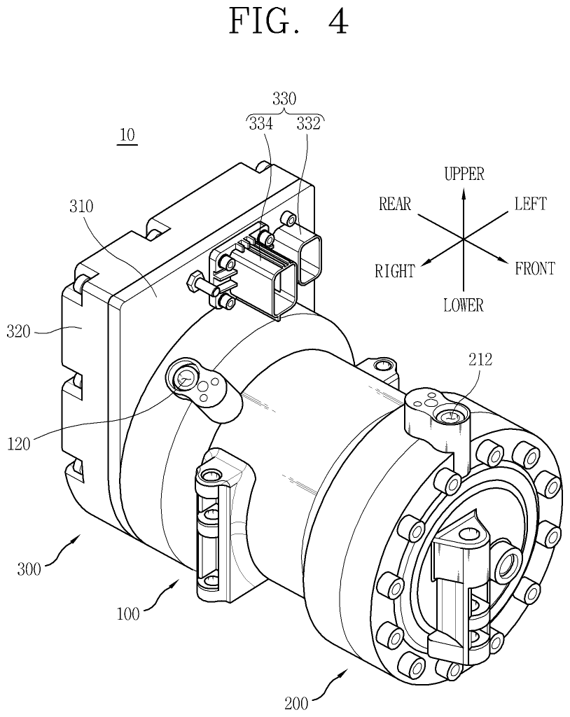

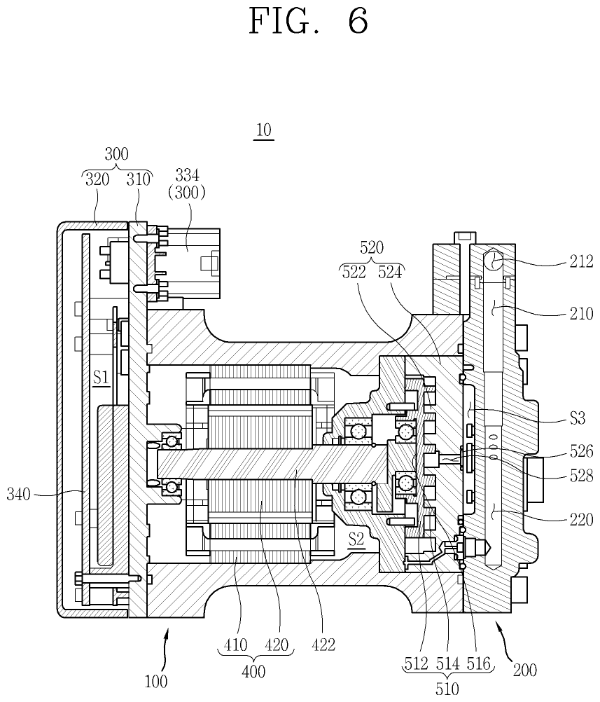

The terms “front,” “rear,” “upper,” “lower,” “right,” and “left” as used herein will be understood with reference to the coordinate systems shown in FIGS. 4 and 6.

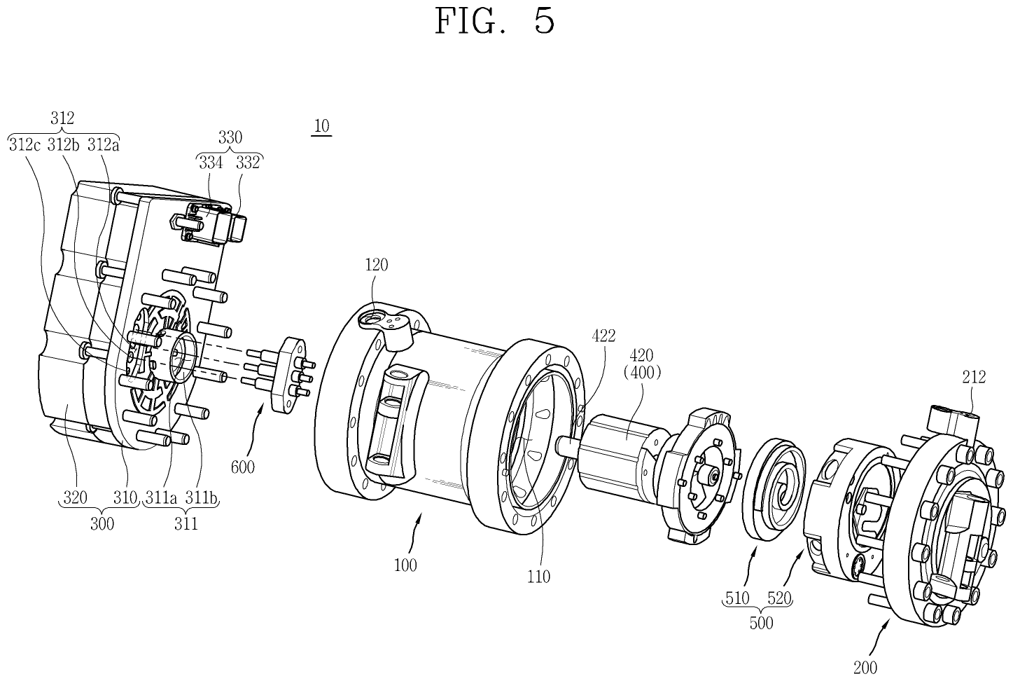

Referring to FIGS. 4 to 6, the electric compressor 10 according to an embodiment of the present disclosure may comprise a main housing 100, a rear housing 200, an inverter 300, a motor part 400, and a compression part 500.

Also, the electric compressor 10 according to an embodiment of the present disclosure may comprise an electrically conductive part 600 for electrically connecting the inverter 300 and the motor part 400.

The elements of the electric compressor 10 according to an embodiment of the present disclosure will be described below with reference to FIGS. 4 to 6. However, the electrically conductive part 600 will be described in another section.

The main housing 100 may form a portion of the external appearance of the electric compressor 10. Also, the main housing 100 may form the body of the electric compressor 10 and may comprise a space formed therein.

A device for driving the electric compressor 10 may be housed in the space. In detail, the motor part 400 and the compression part 500 may be housed in the inner space of the main housing 100.

In an embodiment that is not shown, a fixed scroll 520 of the compression part 500 may not be housed in the main housing 100. In the above embodiment, the fixed scroll 520 may be located between the main housing 100 and the rear housing 200.

The main housing 100 may have a cylindrical shape extending lengthwise, that is, along the front-rear direction in the shown embodiment. The main housing 100 may have any shape capable of housing the motor part 400, the compression part 500, and other devices necessary to drive the electric compressor 10 therein.

However, considering that refrigerant introduced into the main housing 100 is compressed with high pressure and an orbiting scroll 510 is eccentrically rotated, the main housing 100 may be formed to have a circular cross-section, which is a shape with high pressure resistance.

The rear housing 200 may be connected in fluid communication with one side in the length direction of the main housing 100, that is, the front side of the main housing 100 in the shown embodiment.

In an embodiment that is not described above, that is, in an embodiment in which the fixed scroll 520 is located between the main housing 100 and the rear housing 200, the main housing 100, the fixed scroll 520, and the rear housing 200 may be connected in fluid communication with one another.

The refrigerant introduced into the main housing 100 may be compressed by the compression part 500 that may be rotated when the motor part 400 is driven. The compressed refrigerant may be introduced into a discharge chamber S3 through a discharge port 528 formed at the fixed scroll 520.

The inverter 300 may be electrically connected to the other side in the length direction of the main housing 100, that is, the rear side of the main housing 100 in the shown embodiment.

Power and a control signal applied by the inverter 300 may be transferred to the motor part 400. The motor part 400 may be driven by the transferred power and control signal to generate a rotational force to be used by the compression part 500 to compress refrigerant.

The main housing 100 may comprise a motor chamber 110 and an intake port 120.

The motor chamber 110 may comprise a space where the motor part 400 may be housed. The motor chamber 110 may be defined as an inner space of the main housing 100. In other words, the motor chamber 110 may comprise a space partitioned by an inner circumferential surface of the main housing 100.

Alternatively, the motor chamber 110 may be housed in the main housing 100 and may be provided as a separate housing having a space formed therein. In this case, the separately provided housing may be brought in contact with the inner circumferential surface of the main housing 100.

When the motor part 400 is housed in the motor chamber 110, an outer circumferential surface of a stator 410 of the motor part 400 may be fixed on an inner circumferential surface of the motor chamber 110. Accordingly, the stator 410 may stably remain stationary even when power and a control signal are applied from the inverter 300 to the motor part 400.

In an embodiment that is not shown, a protrusion (not shown) may be formed on the inner circumferential surface of the motor chamber 110, and a blind hole (not shown) may be formed on the stator 410. When the motor part 400 is housed in the motor chamber 110, the protrusion (not shown) and the blind hole (not shown) may be in engagement with each other.

In this case, the direction in which the motor part 400 is housed in the motor chamber 110 may be limited, and it may be possible to prevent the motor part 400 from being housed in a wrong direction.

The intake port 120 may enable the inside and outside of the main housing 100 to communicate with each other. The refrigerant outside the electric compressor 10 may be introduced into the main housing 100 through the intake port 120. The introduced refrigerant may be compressed by passing through the motor chamber 110, a back-pressure chamber S2, and the discharge chamber S3 in sequence and then may be discharged to the outside of the electric compressor 10 through an exhaust port 212 of the rear housing 200.

The intake port 120 may be formed through the outer circumferential surface of the main housing 100. In the shown embodiment, the intake port 120 may be located on one side of the main housing 100 opposite to the rear housing 200. In other words, the intake port 120 may be located on one side of the main housing 100 adjacent to the inverter 300.

Also, the intake port 120 may be formed as a circular through-hole passing through the main housing 100.

The location and shape of the intake port 120 may be formed in any form capable of enabling the inside and the outside of the housing 100 to communicate with each other and allowing refrigerant to be introduced into the main housing 100.

As will be described later, however, a large amount of heat may be generated in the inverter device 350 housed in the inverter 300. Also, the refrigerant introduced into the main housing 100 may be configured to cool the large amount of heat to some extent.

In consideration of this point, the intake port 120 may be located adjacent to the inverter 300.

The rear housing 200 may form a portion of the external appearance of the electric compressor 10. In detail, the rear housing 200 may be located on one side of the main housing 100, that is, in front of the main housing 100 in the shown embodiment to form a front appearance of the electric compressor 10.

Alternatively, the fixed scroll 520 of the compression part 500 may be located between the rear housing 200 and the main housing 100.

The rear housing 200 may be configured to communicate with the main housing 100. Refrigerant introduced into the main housing 100 through the intake port 120 of the main housing 100 may be compressed in the compression part 500 and then discharged to the outside through the rear housing 200.

In the shown embodiment, the rear housing 200 may have the shape of a cap having a circular cross-section. The shape of the rear housing 200 may be changeable.

However, the rear housing 200 and the main housing 100 may need to be combined with each other to communicate with each other while sealed from the outside. Considering this point, the rear housing 200 may have a shape corresponding to the shape of the main housing 100.

The rear housing 200 and the main housing 100 may be combined with each other through a separate fastening means (not shown). The fastening means (not shown) may combine and seal the rear housing 200 and the main housing 100.

The rear housing 200 may comprise an exhaust flow path 210 and an oil discharge flow path 220.

The exhaust flow path 210 may be a passage through which the refrigerant compressed by the compression part 500 can be discharged. The exhaust flow path 210 may communicate with the discharge chamber S3.

The exhaust port 212 configured to enable the inside and outside of the rear housing 200 to communicate with each other may be formed on one end of the exhaust flow path 210, that is, an upper end of the exhaust flow path 210 in the shown embodiment. In an embodiment, the exhaust port 212 may be formed as a through-hole.

The refrigerant compressed in the compression part 500 may enter the exhaust flow path 210 through the discharge chamber S3. In this case, the refrigerant introduced into the exhaust flow path 210 may be mixed with oil. When oil remains in the refrigerant discharged through the exhaust port 212, cooling efficiency of an air conditioning system can be reduced. Furthermore, the oil may cause an apparatus included in the air conditioning system to be damaged.

Thus, a cyclone apparatus (not shown) or the like configured to separate oil from refrigerant may be provided inside the exhaust flow path 210.

The oil discharge flow path 220 may be a flow path through which the oil separated from the refrigerant moves. The oil discharge flow path 220 may communicate with the exhaust flow path 210. A residual mixture of the refrigerant and the oil or the oil separated from the refrigerant in the exhaust flow path 210 may move to a lower side of the rear housing 200 through the oil discharge flow path 220.

The oil discharge flow path 220 may communicate with an oil flow path part (not shown). The residual mixture of the refrigerant and the coil or the oil moving to the lower side of the rear housing 200 may move back to the compression part 500 through the oil flow path part (not shown).

The inverter 300 may be configured to control operation of the electric compressor 10. In detail, the inverter 300 may control operation of the electric compressor 10 by applying or releasing power a control signal to the motor part 400.

The inverter 300 may receive the power and the control signal from the outside of the electric compressor 10. To this end, the inverter 300 may be electrically connected to a control unit (not shown) located outside the electric compressor 10.

The inverter 300 may apply the received power and control signal to the motor part 400. To this end, the inverter 300 may be electrically connected to the motor part 400.

The electric compressor 10 according to an embodiment of the present disclosure may comprise an electrically conductive part 600 for simply forming electrically conductive connection between the inverter 300 and the motor part 400. This will be described in detail below.

The inverter 300 may be located on one side of the main housing 100. In detail, the inverter 300 may be located on one side of the main housing 100 opposite to the rear housing 200.

The inverter 300 may be electrically connected to the motor part 400 and may be provided at any position to which the power and control signal can be applied.

In an embodiment that is not shown, the inverter 300 may communicate with the main housing 100. In the above embodiment, a portion of the refrigerant introduced through the intake port 120 may be introduced into the inverter 300 to directly cool the inverter device 350.

The inverter 300 may comprise an inverter housing 310, an inverter cover 320, an inverter connector 330, a printed circuit board 340, and an inverter device 350.

The inverter housing 310 may form the external appearance of the inverter 300 together with the inverter cover 320. In detail, the inverter housing 310 may be a part where the inverter 300 can coupled to the main housing 100.

The inverter housing 310 may be located on one side of the inverter 300 facing the main housing 100.

The inverter housing 310 may be formed of a high thermal conductivity material to effectively cool the inverter device 350 housed in the inverter 300 through heat exchange with the refrigerant introduced into the main housing 100.

The refrigerant introduced into the intake port 120 may be configured to cool the inverter device 350 through heat change with the inverter housing 310.

The inverter cover 320 may be coupled to one side of the inverter housing 310 opposite to the main housing 100, that is, the rear side of the inverter housing 310 in the shown embodiment.

A space formed by coupling the inverter housing to the inverter cover 320 may be defined as an inverter chamber S1. The printed circuit board 340 and the inverter device 350 may be housed in the inverter chamber S1. Also, any devices that are not shown may be housed in the inverter chamber S1 to input and output power and a control signal.

The inverter connector 330 may be located above the inverter housing 310. The inverter connector 330 may be configured to receive power and a control signal from the outside.

The inverter housing 310 may comprise a rotary shaft support part 311 and a connector coupling part 312.

The rotary shaft support part 311 may be a part to which a rotary shaft 422 of the motor part 400 can be coupled. The rotary shaft support part 311 may not be rotated irrespective of the rotation of the rotary shaft 422. The rotary shaft 422 may be coupled to the rotary shaft support part 311 and may be freely rotated. That is, the rotary shaft support part 311 may be configured to support one end of the rotary shaft 422, that is, one end facing the inverter 300.

The rotary shaft support part 311 may be formed on one surface of the inverter housing 310 facing the main housing.

A circular blind hole 311a may be formed on the rotary shaft support part 311 such that the rotary shaft 422 can be inserted into the blind hole 311a.

A guide part 311b protruding from one surface of the inverter housing 310 may be formed on an outer circumference of the rotary shaft support part 311 and may be configured to support the rotary shaft 422.

A central axis of the rotary shaft support part 311 may be formed coaxially with the stator 410 and the rotor 420 of the motor part 400. Thus, the rotor 420 may be stably rotated.

The connector coupling part 312 may be a part to which the electrically conductive part 600 can be coupled. The connector coupling part 312 may comprise a support member insertion blind hole 312a, an input terminal insertion hole 312b, and a fastening hole 312c.

A support member 610 of the electrically conductive part 600 may be inserted into and coupled to the support member insertion blind hole 312a. The support member insertion blind hole 312a may be recessed a predetermined distance from one surface of the inverter housing 310 facing the main housing 100.

The shape and recessed distance of the support member insertion blind hole 312a may be determined according to the shape of the support member 610 of the electrically conductive part 600.

In an embodiment, the support member insertion blind hole 312a may be configured to perfectly house the support member 610. That is, one surface of the support member 610 facing the main housing 100 may be coplanar with one surface of the inverter housing 310 facing the main housing 100.

An input terminal 621 of the electrically conductive part 600 may be inserted into and coupled to the input terminal insertion hole 312b. The input terminal 621 may be electrically connected to the printed circuit board 340 and the inverter device 350 housed in the inverter chamber S1.

Accordingly, the input terminal insertion hole 312b may be formed through the inverter housing 310. The input terminal 621 may be inserted into and through the input terminal insertion hole 312b and thus may be electrically connected to the printed circuit board 340 and the inverter device 350.

A connection member 630 of the electrically conductive part 600 may also be inserted into and coupled to the input terminal insertion hole 312b. To this end, the diameter of the cross section of the input terminal insertion hole 312b may be equal to or larger than the outer diameter of the cross section of the connection member 630.

When the coupling between the electrically conductive part 600 and the inverter 300 is complete, the input terminal 621 of the electrically conductive part 600 may be electrically connected to the printed circuit board 340 and the inverter device 350 through the input terminal insertion hole 312b. Also, the connection member 630 of the electrically conductive part 600 may be inserted into the input terminal insertion hole 312b.

In the shown embodiment, a total of three input terminal insertion holes 312b may be formed and spaced a predetermined distance from one another in the length direction of the connector coupling part 312.

This is due to the fact that an electric current applied to the electric compressor 10 according to an embodiment of the present disclosure may comprise a three-phase current, as will be described later. In an embodiment, currents of U phase, V phase, and W phase may be applied to the electric compressor 10 according to an embodiment of the present disclosure.

The number of input terminal insertion holes 312b may be changed depending on the number and types of phases applied to the electric compressor 10.

A fastening member (not shown) for coupling the inverter 300 to the electrically conductive part 600 may be inserted into and coupled to the fastening hole 312c. In this case, the fastening hole 312c may be recessed a predetermined distance from one surface of the connector coupling part 312 facing the main housing 100.

In an embodiment, a fastening member (not shown) may be inserted through and coupled to the fastening hole 312c. In this case, the fastening hole 312c may be formed through the inverter housing 310.

The fastening member (not shown) may be any member capable of coupling two or more different members such as a screw or a rivet.

In the shown embodiment, two fastening holes 312c may be formed on the support member insertion blind hole 312a. In detail, the fastening holes 312c may be spaced a predetermined distance from each other and may be located outward from the input terminal insertion holes 312b located at the outermost sides among the input terminal insertion holes 312b formed along the length direction of the support member insertion blind hole 312a.

The number and locations of fastening holes 312c may be determined to correspond to the number and shape of fastening holes 612 of the support member 610.

The inverter cover 320 may form the external appearance of the inverter 300 together with the inverter housing 310. The inverter cover 320 may be located on one side of the inverter housing 310 opposite to the main housing 100, that is, the rear side of the inverter housing 310 in the shown embodiment.

The inverter cover 320 may be coupled to the inverter housing 310. A space may be formed between the inverter cover 320 and the inverter housing 310 coupled to each other. The space may be defined as the inverter chamber S1 where the printed circuit board 340, the inverter device 350, and the like are to be housed.

The inverter cover 320 may be coupled to the inverter housing 310 by a separate fastening means (not shown).

The inverter connector 330 may be configured to receive power and a control signal from the outside of the electric compressor 10. The power and control signal received by the inverter connector 330 may be transferred to the motor part 400 to drive the motor part 400.

In the shown embodiment, the inverter connector 330 may be located above the inverter housing 310. The inverter connector 330 may be provided at any location capable of receiving power and a control signal from the outside.

The inverter connector 330 may comprise a communication connector 332 for receiving a control signal and a power connector 334 for receiving a power signal. Additionally or alternatively, the inverter connector 330 may be provided as a single connector and configured to receive power and a control signal through one connector.

A process of calculating the power and control signal transferred to the inverter device 350 housed in the inverter chamber S1 through the inverter connector 330 is well known in the art, and thus a detailed description thereof will be omitted.

The printed circuit board 340 may generate power and control signal to be transferred to the motor part 400 together with the inverter device 350. In detail, the printed circuit board 340 and the inverter device 350 may be configured to convert the power and control signal transferred from the outside into power and a control signal for driving the motor part 400.

Also, the printed circuit board 340 and the inverter device 350 may be configured to acquired information regarding the motor part 400 being driven and transfer the information to an external control unit (not shown).

The printed circuit board 340 and the inverter device 350 may be electrically connected to the external control unit (not shown). Also, the printed circuit board 340 and the inverter device 350 may be electrically connected to each other.

The printed circuit board 340 may comprise an input terminal housing part 341 and an input terminal connection part 342.

The input terminal housing part 341 may house the input terminal 621 of the electrically conductive part 600. In the shown embodiment, the input terminal housing part 341 may be formed in the form of a through-hole. The input terminal housing part 341 may be formed in any form capable of housing the input terminal 621.

In the shown embodiment, the input terminal housing part 341 may comprise a first input terminal housing part 342a, a second input terminal housing part 342b, and a third input terminal housing part 342c. A first input terminal 621a, a second input terminal 621b, and a third input terminal 621c may be housed in the input terminal housing parts 342a, 342b, and 342c, respectively.

This may be due to the application of a three-phase current to the electric compressor 10 according to an embodiment of the present disclosure.

The locations and number of input terminal housing parts 341 may be changed to correspond to the locations and number of input terminals 621.

When the input terminal 621 is housed in the input terminal housing part 341, the input terminal 621 may be fixed on the input terminal housing part 341 by a method such as soldering.

The input terminal connection part 342 may be in contact with the input terminal 621 to electrically connect the inverter 300 to the electrically conductive part 600.

In the shown embodiment, the input terminal connection part 342 may be provided in the input terminal housing part 341. The input terminal connection part 342 may have any shape capable of being brought in contact with the input terminal 621 housed in the input terminal housing part 341.

One side of the input terminal connection part 342 may be electrically connected to the printed circuit board 340. Accordingly, when the input terminal 621 is in electrically conductive contact with the input terminal connection part 342, the input terminal 621 may be electrically connected to the printed circuit board 340 and the inverter device 350.

A through-hole may be formed in the input terminal connection part 342. The input terminal 621 may be inserted through and coupled to the through-hole. The location and shape of the through-holes may be determined depending on the location and shape of the input terminal 621.

The input terminal connection part 342 may be formed of a conductive material. In an embodiment, the input terminal connection part 342 may be formed of iron, copper, an alloy of iron and nickel, an alloy of copper and nickel, or the like.

When the input terminal 621 is housed in the input terminal housing part 341, the input terminal 621 may be in contact with the input terminal connection part 342. Subsequently, the input terminal 621 and the input terminal connection part 342 may remain in contact with each other through a method such as soldering.

The motor part 400 may generate a rotational force for rotating the compression part 500 to compress refrigerant. To this end, the motor part 400 may be rotatably connected to the orbiting scroll 510 of the compression part 500.

The motor part 400 may be electrically connected to the inverter 300. The motor part 400 may be configured to receive power and a control signal from the inverter 300. This may be accomplished by the electrically conductive part 600 to be described later.

The motor part 400 may be housed in the motor chamber 110 of the main housing 100. In detail, the motor part 400 may be housed in the motor chamber 110 such that an outer circumferential surface of the stator 410 forming the outside of the motor part 400 can be in contact with an inner circumferential surface of the motor chamber 110.

Thus, when the power and control signal are applied from the inverter 300, only the rotor 420 may be rotated while the stator 410 is not rotated.

The motor part 400 may comprise the stator 410, the rotor 420, and an output terminal housing part 430.

The stator 410 may form an electromagnetic field according to the power and control signal applied by the inverter 300. The formed electric field may affect an electromagnetic force to a magnet included in the rotor 420. Accordingly, the rotor 420 may be rotated, and thus the orbiting scroll 510 may be rotated.

The stator 410 may comprise a plurality of coils (not shown). The plurality of coils (not shown) may be wound around the stator 410. An electric current having a different phase may flow through each of the plurality of coils (not shown). In an embodiment, an electric current having any one of U phase, V phase, and W phase may flow through each of the coils (not shown).

The stator 410 may form the outside of the motor part 400. When the motor part 400 is housed in the motor chamber 110, the outer circumferential surface of the stator 410 may be brought in contact with the inner circumferential surface of the motor chamber 110.

The stator 410 may be housed and fixed in the motor chamber 110. Even when the power and control signal are transferred from the inverter 300 and the motor part 400 is operated, the stator 410 may not be rotated.

A space may be formed inside the stator 410. In the shown embodiment, the stator 410 may have a cylindrical shape extending lengthwise. A hollow portion extending lengthwise may be formed inside the stator 410. The space may be defined by the hollow portion.

The rotor 420 may be housed in the hollow portion. The rotor 420 may be spaced a predetermined distance from the stator 410. The rotor 420 and the stator 410 may not be in contact with each other.

The output terminal housing part 430 may be provided on one side of the stator 410 facing the main housing 100, that is, the rear side of the stator 410 in the shown embodiment. The output terminal housing part 430 may be electrically connected to the electrically conductive part 600.

The rotor 420 may be rotated by an electromagnetic field formed by the plurality of coils (not shown) provided in the stator 410. The rotor 420 may comprise a plurality of magnets.

When the plurality of coils (not shown) of the stator 410 forms an electromagnetic field, the plurality of magnets of the rotor 420 may receive an electromagnetic force. By the electromagnetic force, the rotor 420 may be rotated clockwise or counterclockwise.

The rotor 420 may be housed in a space formed inside the stator 410. The rotor 420 may be spaced a predetermined distance from the stator 410. That is, an outer circumferential surface of the rotor 420 and an inner circumferential surface of the stator 410 may not be in contact with each other.

Accordingly, the rotor 420 may be rotated relative to the stator 410, irrespectively of the stator 410.

The rotor 420 may be rotatably connected to the orbiting scroll 510 of the compression part 500. The rotor 420 may be rotated integrally with the orbiting scroll 510.

The rotor 420 may comprise the rotary shaft 422.

The rotary shaft 422 may be configured to transfer the rotation of the rotor 420 to the orbiting scroll 510. The orbiting scroll 510 may be rotatably coupled to one side of the rotary shaft 422 facing the rear housing 200, that is, the front side of the rotary shaft 422 in the shown embodiment.

That is, the rotary shaft 422 and the orbiting scroll 510 may be coupled to each other such that the orbiting scroll 510 can be integrally rotated when the rotary shaft 422 is rotated.

The other side of the rotary shaft 422 facing the inverter 300, that is, the rear side of the rotary shaft 422 may be inserted into the rotary shaft support part 311 of the inverter 300. The rotary shaft support part 311 may support the rotary shaft 422, but may not be rotated irrespective of the rotation of the rotary shaft 422.

Accordingly, the rotary shaft 422 may rotate the orbiting scroll 510 along with the rotation of the rotor 420 while stably supported by the rotary shaft support part 311.

The output terminal housing part 430 may electrically connect the electrically conductive part 600 to the stator 410. The power and control signal applied by the inverter 300 may be transferred to the output terminal housing part 430 through the electrically conductive part 600.

An output terminal 622 of the electrically conductive part 600 may be electrically housed in the output terminal housing part 430. Also, the output terminal 622 may be detachably housed in the output terminal housing part 430.

The power and control signal transferred to the output terminal housing part 430 may be transferred to the stator 410. The output terminal housing part 430 and the stator 410 may be electrically connected to each other by a member such as a conducting wire (not shown).

In the shown embodiment, the output terminal housing part 430 may be located on one side of the motor part 400 facing the inverter 300.

In the shown embodiment, the output terminal housing part 430 may comprise an output terminal insertion part 431 into which the output terminal 622 is to be inserted. The output terminal insertion part 431 may be formed in a space where an opening is formed on one side facing the inverter 300.

A conductive member may be provided in the output terminal insertion part 431. That is, when the output terminal 622 is inserted into the output terminal insertion part 431, a conductive member configured to occupy a space other than a space occupied by the output terminal 622 out of the space of the output terminal insertion part 431 may be provided.

In the shown embodiment, the output terminal insertion part 431 may include three parts, that is, a first output terminal insertion part 431a, a second output terminal insertion part 431b, and a third output terminal insertion part 431c. This may be due to the application of a three-phase current to the electric compressor 10 according to an embodiment of the present disclosure, as described above.

The number of output terminal insertion parts 431 provided in the output terminal housing part 430 may be changed depending on the number of output terminals 622 of the electrically conductive part 600 and the number of phases of the applied current.

Also, the sizes and shapes of the output terminal insertion parts 431a, 431b, and 431c may be changed to correspond to the size and shape of the output terminal 622 of the electrically conductive part 600.

The compression part 500 may be rotated by a rotational force generated by the motor part 400 to substantially serve to compress refrigerant.

The compression part 500 may be rotatably connected to the rotor 420 by the rotary shaft 422. When the rotor 420 is rotated, the rotary shaft 422 and the compression part 500 may be integrally rotated.

The compression part 500 may comprise the orbiting scroll 510 and the fixed scroll 520.

The orbiting scroll 510 may be rotated along with the rotation of the motor part 400. The orbiting scroll 510 may be rotatably coupled to the rotary shaft 422 of the rotor 420. That is, when the rotary shaft 422 is rotated, the orbiting scroll 510 may also be integrally rotated.

The orbiting scroll 510 may have a central axis different from those of the rotor 420 and the rotary shaft 422. When the rotor 420 is rotated, the orbiting scroll 510 may be rotated eccentrically with respect to the central axis of the rotor 420.

On the other hand, the fixed scroll 520 may have the same central axis as the rotor 420. Accordingly, the orbiting scroll 510 may be rotated eccentrically with respect to the central axis of the fixed scroll 520.

Thus, refrigerant introduced between a fixed wrap 524 of the fixed scroll 520 and an orbiting wrap 514 of the orbiting scroll 510 may be compressed.

The orbiting scroll 510 may be housed in the main housing 100. Also, the orbiting scroll 510 may be housed to be eccentrically rotatable in the space inside the main housing 100.

The orbiting scroll 510 may be located on one side of the motor chamber 110 adjacent to the rear housing 200, that is, the front side of the motor chamber 110 in the shown embodiment.

The orbiting scroll 510 may comprise an orbiting end plate part 512, the orbiting wrap 514, and a rotary shaft coupling part 516.

The orbiting end plate part 512 may form the body of the orbiting scroll 510. In the shown embodiment, the orbiting end plate part 512 may form the rear side of the orbiting scroll 510.

One surface of the orbiting end plate part 512, that is, the front surface of the orbiting end plate part 512 in the shown embodiment may be in contact with the rear surface of the fixed wrap 524 of the fixed scroll 520.

The orbiting wrap 514 may be coupled to the fixed wrap 524 of the fixed scroll 520 with a predetermined space formed therebetween. The orbiting wrap 514 may be rotated eccentrically with respect to the rotary shaft 422 while coupled to the fixed wrap 524. Thus, refrigerant introduced into the space between the orbiting wrap 514 and the fixed wrap 524 may be compressed.

The orbiting wrap 514 may be formed to protrude from the orbiting end plate part 512. In the shown embodiment, the orbiting wrap 514 may be formed to protrude in a direction facing the rear housing 200.

In the shown embodiment, the orbiting wrap 514 may be spirally formed. The orbiting wrap 514 may have any shape capable of being coupled in engagement with the fixed wrap 524 and eccentrically rotated relative to the fixed wrap 524.

The rotary shaft coupling part 516 may be a part where the rotary shaft 422 of the rotor 420 can be coupled to the orbiting scroll 510.

The rotary shaft coupling part 516 may be formed through the orbiting end plate part 512. In the shown embodiment, the rotary shaft coupling part 516 may be formed through the orbiting end plate part 512 in the front-rear direction thereof.

An eccentric part (not shown) may be coupled to the rotary shaft coupling part 516. The eccentric part (not shown) may be configured to change the rotary shaft of the orbiting scroll 510 such that the orbiting scroll 510 is rotated eccentrically with respect to the rotary shaft 422.

The fixed scroll 520 may not be rotated irrespective of the rotation of the motor part 400. Accordingly, when the motor part 400 is operated, the orbiting scroll 510 may be rotated relative to the fixed scroll 520.

The fixed scroll 520 may be housed in the main housing 100. In detail, the fixed scroll 520 may have one side located adjacent to the orbiting scroll 510 and the other side located adjacent to the rear housing 200.

In an embodiment that is not shown, the fixed scroll 520 may be exposed to the outside of the electric compressor 10. In the above embodiment, the fixed scroll 520 may be located between the main housing 100 and the rear housing 200.

One surface of the fixed scroll 520 adjacent to the rear housing 200, that is, the front surface of the fixed scroll 520 may be coupled to the rear housing 200 with a predetermined space formed therebetween. The space formed between the fixed scroll 520 and the rear housing 200 may be defined as the discharge chamber S3 through which refrigerant may pass before entering the exhaust flow path 210.

The fixed scroll 520 may be relatively rotatably coupled to the orbiting scroll 510. As described above, the orbiting scroll 510 may be rotated relative to the fixed scroll 520 because the fixed scroll 520 remains fixed.

The fixed scroll 520 may comprise a fixed end plate part 522, the fixed wrap 524, a discharge valve 526, and a discharge port 528. Also, a rotary shaft coupling part (not shown) may be formed in the fixed scroll 520, and thus the rotary shaft 422 may be rotatably coupled to the rotary shaft coupling part.

However, as described above, the fixed scroll 520 may not be rotated along with the rotation of the rotary shaft 422. Therefore, it can be seen that the rotary shaft coupling part (not shown) provided in the fixed scroll 520 may support one side of the rotary shaft 422.

The fixed end plate part 522 may form the body of the fixed scroll 520. In the shown embodiment, the fixed end plate part 522 may form the front side of the fixed scroll 520.

One surface of the fixed end plate part 522, that is, the rear surface of the fixed end plate part 522 in the shown embodiment may be in contact with the front surface of the orbiting wrap 514 of the orbiting scroll 510.

In the shown embodiment, a plurality of blind holes may be formed on the outer circumferential surface of the fixed end plate part 522. The blind holes may be intended to reduce the weight of the electric compressor 10, and the shape and number thereof may be changed.

The fixed wrap 524 may be coupled to the orbiting wrap 514 of the orbiting scroll 510 with a predetermined space formed therebetween. That is, the fixed wrap 524 may be spaced a predetermined distance from and engaged with the orbiting wrap 514.

When the orbiting scroll 510 is rotated by the motor part 400 after the fixed wrap 524 is coupled to the orbiting wrap 514, refrigerant may be compressed in the space between the fixed wrap 524 and the orbiting wrap 514.

The fixed wrap 524 may be formed to protrude from the fixed end plate part 522. In the shown embodiment, the fixed wrap 524 may be formed to protrude rearward from the fixed end plate part 522.

In the shown embodiment, the fixed wrap 524 may be spirally formed. The fixed wrap 524 may have any shape capable of being coupled in engagement with the orbiting wrap 514 such that the orbiting wrap 514 is rotated relatively eccentrically with respect to the fixed wrap 524.

The discharge valve 526 may be configured to open or close the discharge port 528, which may be a passage through which refrigerant compressed by the relative rotation between the orbiting scroll 510 and the fixed scroll 520 can be introduced into the discharge chamber S3.

In an embodiment, the discharge valve 526 may be provided as a check valve such as a reed valve that restricts a flow of fluid in a single direction depending on the pressure.

The discharge valve 526 may be located on one side of the fixed end plate part 522 opposite to the fixed wrap 524, that is, on the front side of the fixed end plate part 522 in the shown embodiment. Also, the discharge valve 526 may be configured to cover the discharge port 528.

When the pressure of the compressed refrigerant is greater than or equal to a predetermined pressure, the discharge valve 526 may open the discharge port 528. Thus, the compressed refrigerant may be introduced into the discharge chamber S3.

When the pressure of the compressed refrigerant is less than a predetermined pressure, the discharge valve 526 may close the discharge port 528. Thus, the less compressed refrigerant may be prevented from being introduced into the discharge chamber S3.

The discharge port 528 may be a passage through which the compressed refrigerant can be introduced into the discharge chamber S3 by the orbiting scroll 510 and the fixed scroll 520. The discharge port 528 may connect the space formed between the orbiting wrap 514 and the fixed wrap 524 in fluid communication with the discharge chamber S3.

The discharge port 528 may be opened or closed. In detail, the discharge valve 526 may be provided in the discharge port 528 and may be opened or closed depending on the pressure of the compressed refrigerant.

The refrigerant discharged through the discharge port 528 may be discharged to the outside of the electric compressor 10 through the exhaust port 212 via the discharge chamber S3 and the exhaust flow path 210 in sequence.

In addition to the above elements, the electric compressor 10 according to an embodiment of the present disclosure may include various elements for compressing refrigerant.

Also, although not shown, a refrigerant flow path through which refrigerant can be introduced, compressed, and then discharged to the outside of the electric compressor 10, and a member for forming the refrigerant flow path may be provided.

Likewise, although not shown, an oil flow path through which oil can be supplied to the compression part 500 and through which oil compressed in the compression part together with refrigerant can be supplied back to the compression part 500 after the oil is discharged to the rear housing 200 through the oil discharge flow path 220, and a member for forming the oil flow path may be provided.

The electric compressor 10 according to an embodiment of the present disclosure may comprise the electrically conductive part 600 for electrically connecting the inverter 300 and the motor part 400. The electrically conductive part 600 may be detachably coupled to the inverter 300 and the motor part 400.

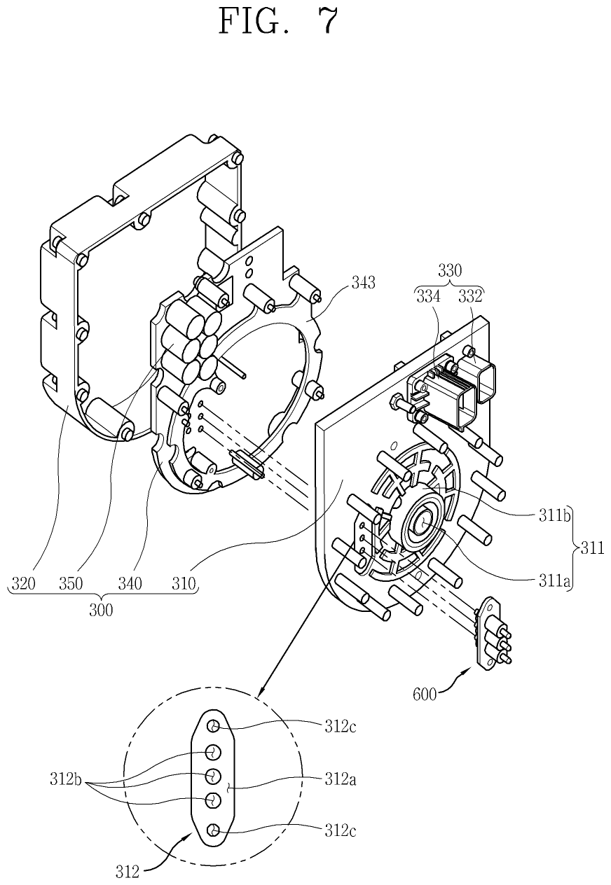

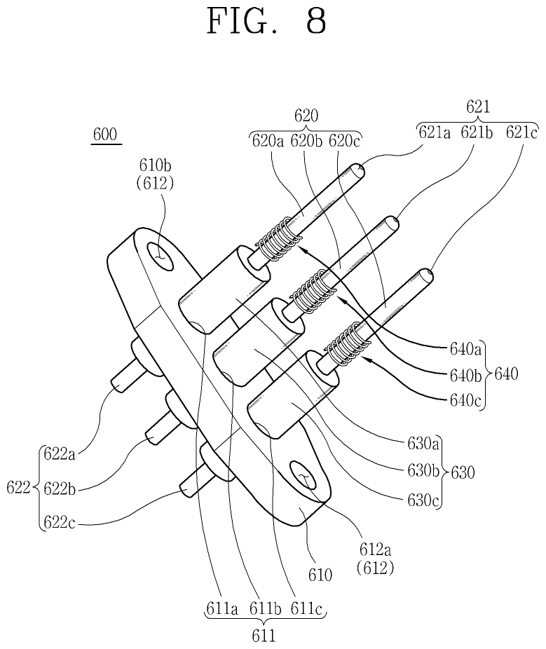

The electrically conductive part 600 according to an embodiment of the present disclosure will be described in detail below with reference to FIGS. 7 to 10.

The electrically conductive part 600 may electrically connect the inverter 300 and the motor part 400. Thus, power and a control signal may be applied from the inverter 300 to the motor part 400.

Also, the electrically conductive part 600 may be detachably coupled to the inverter 300 and the motor part 400. Thus, the inverter 300 and the motor part 400 may be electrically connected to each other through a simple structure.

Since the electrically conductive part 600 is provided, the electric compressor 10 according to an embodiment of the present disclosure may not need a complicated wiring structure for electrically connecting the inverter 300 and the motor part 400.

Also, the electrically conductive part 600 may be in contact with the inverter device 350 such that they are electrically conductive to each other. Accordingly, there may be no need to provide a busbar assembly requiring an inverter according to the prior art.

In the shown embodiment, the electrically conductive part 600 may comprise a support member 610, a terminal member 620, a connection member 630, and an elastic member 640.

The following description assumes that the input terminal 621 and the output terminal 622 are provided as a single electrically-conductive terminal. That is, one side and the other side of the electrically conductive terminal may be defined as the input terminal 621 and the output terminal 622, respectively.

Alternatively, the input terminal 621 and the output terminal 622 may be provided as separate terminals and electrically connected to each other in the support member 610.

The support member 610 may form the body of the electrically conductive part 600. The terminal member 620 may be inserted into and electrically coupled to the support member 610.

Alternatively, the input terminal 621 and the output terminal 622, which may be provided as separate terminals, may be inserted into and coupled to the support member 610. In the above embodiment, the input terminal 621 and the output terminal 622 may be in electrically conductive contact with each other while inserted into and coupled to the support member 610.

When the electrically conductive part 600 is coupled to the inverter 300, the support member 610 may be inserted into and coupled to the support member insertion blind hole 312a of the inverter 300. In an embodiment, the support member 610 may be coupled to and wholly housed in the support member insertion blind hole 312a.

That is, one surface of the support member 610 facing the main housing 100 may be coplanar with one surface of the inverter housing 310 facing the main housing 100.

In the shown embodiment, the support member 610 may be formed to extend in the width direction, and both ends in the width direction, that is, the vertical direction in the shown embodiment may be formed as a curved surface. The support member 610 may have any shape capable of supporting the coupled terminal member 620 and electrically coupling to the inverter 300 and the motor part 400.

The support member 610 may be formed of a non-conductive material so as to prevent power and a control signal applied through the terminal member 620 from being leaked or mixed with noise unintentionally.

The support member 610 may comprise a terminal coupling part 611 and a fastening hole 612.

The terminal member 620 may be inserted through and coupled to the terminal coupling part 611. Also, the connection member 630 may be inserted through and coupled to the terminal coupling part 611.

The terminal coupling part 611 may be formed through the support member 610 in the length direction, that is, in the front-rear direction in the shown embodiment.

In the shown embodiment, a total of three terminal coupling parts 611, that is, a first terminal coupling part 611a, a second terminal coupling part 611b, and a third terminal coupling part 611c may be formed in the support member 610 and spaced a predetermined distance from one another. This may be due to the application of a three-phase current to the electric compressor 10 according to an embodiment of the present disclosure, as described above.

The number of terminal coupling parts 611 may be changed depending on the number of phases of the applied current. Also, the location of the terminal coupling part 611 may be changed to correspond to the location of the input terminal insertion hole 312b of the inverter housing 310.

In the shown embodiment, the terminal coupling part 611 may be formed to have a circular cross section. This may be due to the circular cross-sectional shape of the terminal member 620 and the connection member 630 which may be inserted through and coupled to the terminal coupling part 611.

The shape of the terminal coupling part 611 may be changed depending on the cross-sectional shape of the terminal member 620 and the connection member 630.

The fastening hole 612 may comprise a space into which a fastening member (not shown) for fastening the electrically conductive part 600 and the inverter 300 can be inserted. In the shown embodiment, the fastening hole 612 may include a first fastening hole 612a located on one side in the width direction of the support member 610 and a second fastening hole 612b located on the other side opposite to the one side.

The number and locations of fastening holes 612 may be changed to correspond to the number and locations of fastening holes 312c formed in the inverter housing 310.

After the electrically conductive part 600 is coupled to the inverter 300, a fastening member (not shown) may be inserted into and through the fastening hole 612 and the fastening hole 312c so that the electrically conductive part 600 and the inverter 300 are fastened to each other. Thus, the electrically conductive part 600 and the inverter 300 may stably remain coupled to each other.

The terminal member 620 may be an electrical passage through which the power and control signal applied by the inverter 300 can be transferred to the motor part 400. The terminal member 620 may electrically connect the inverter 300 and the motor part 400.

The terminal member 620 may be formed to extend lengthwise. One side of the terminal member 620 adjacent to the inverter 300 may be defined as the input terminal 621. Likewise, one side of the terminal member 620 adjacent to the motor part 400 may be defined as the output terminal 622.

The terminal member 620 may be formed of a conductive material such as iron (Fe), copper (Cu), an alloy of iron and nickel (Ni), an alloy of copper and nickel, or the like. In an embodiment, the terminal member 620 may be formed of Fe-Ni 50% alloy (an iron alloy with 50% nickel content).

In the shown embodiment, the terminal member 620 may have a total of three terminal members, that is, a first terminal member 620a, a second terminal member 620b, and a third terminal member 620c. The terminal members 620a, 620b, and 620c may be configured such that currents of different phases flow therethrough.

The number of terminal members 620 may be determined depending on the number of phase types of the current applied to the electric compressor 10.

The terminal members 620 may be inserted through and coupled to the terminal coupling part 611 of the support member 610. In detail, the first terminal member 620a may be inserted through and coupled to the first terminal coupling part 611a, the second terminal member 620b may be inserted through and coupled to the second terminal coupling part 611b, and the third terminal member 620c may be inserted through and coupled to the third terminal coupling part 611c.

The terminal member 620 may comprise the input terminal 621 and the output terminal 622.

The input terminal 621 may be a part where the terminal member 620 can be electrically connected to the inverter 300. The input terminal 621 may be defined as one side of the terminal member 620 facing the inverter 300.

The input terminal 621 may be inserted through and coupled to the input terminal insertion hole 312b formed in the inverter housing 310. Also, an end of the input terminal 621 may be housed in the input terminal housing part 341 of the printed circuit board 340.

The input terminal 621 may be electrically connected to the input terminal housing part 341. In detail, the input terminal 621 may be in electrically conductive contact with a conductive material provided to surround the outer circumference of the input terminal housing part 341.

Thus, the input terminal 621 may receive power and a control signal from the printed circuit board 340. The power and control signal received by the input terminal 621 may be transferred to the output terminal 622 along the terminal member 620.

The input terminal 621 may have a total of three input terminals, that is, the first input terminal 621a, the second input terminal 621b, and the third input terminal 621c. The input terminals 621a, 621b, and 621c may be configured such that currents of different phases flow therethrough. This may be due to the application of a three-phase current to the electric compressor 10 according to an embodiment of the present disclosure.

An elastic member 640 may be provided in the input terminal 621. The elastic member 640 may be located between the connection member 630 and an end of the input terminal 621 electrically connected to the input terminal housing part 341.

The input terminal 621 may be inserted through and coupled to the elastic member 640. As will be described below, the elastic member 640 may be provided in the form of a coil spring having a hollow portion formed therein. The input terminal 621 may be inserted through and coupled to the hollow portion of the elastic member 640.

Through the configuration, vibration generated when the motor part 400 is operated may be damped by the elastic member 640. This will be described in detail below.

The output terminal 622 may be a part where the terminal member 620 can be electrically connected to the motor part 400. The output terminal 622 may be defined as one side of the terminal member 620 facing the motor part 400. That is, the output terminal 622 may be opposite to the above-described input terminal 621.

The output terminal 622 may be inserted into and housed in the output terminal housing part 430 provided in the motor part 400.

The output terminal 622 may be electrically connected to the output terminal housing part 430. In detail, when the output terminal 622 is inserted into the output terminal housing part 430, the output terminal 622 and an electrically conductive member (not shown) provided in the output terminal housing part 430 may be in electrically conductive contact with each other.

Thus, the output terminal 622 may receive power and a control signal applied to the input terminal 621 and transfer the power and control signal to the motor part 400.

The output terminal 622 may have a total of three output terminals, that is, the first output terminal 622a, the second output terminal 622b, and the third output terminal 622c. The output terminals 622a, 622b, and 622c may be configured such that currents of different phases flow therethrough. This may be due to the application of a three-phase current to the electric compressor 10 according to an embodiment of the present disclosure.

The connection member 630 may be configured to surround the terminal member 620 in order to prevent unintentional electrical conduction from occurring between the terminal member 620 and other members. Also, the connection member 630 may allow the terminal member 620 to stably remain inserted through and coupled to the terminal coupling part 611.

The connection member 630 may be formed to extend lengthwise. The connection member 630 may have a cylindrical shape having a circular cross section.

The connection member 630 may be configured to partially surround the terminal member 620. In detail, the connection member 630 may be configured to surround parts spaced a predetermined distance from the input terminal 621 and the output terminal 622 included in the terminal member 620.

A hollow portion may be formed inside the connection member 630. The terminal member 620 may be inserted into and coupled to the hollow portion of the connection member 630. An inner circumferential surface of the connection member 630, that is, an outer circumferential surface of the hollow portion and an outer circumferential surface of the terminal member 620 may be brought in contact with each other.

The connection member 630 may be inserted through and coupled to the terminal coupling part 611 of the support member 610. In other words, the connection member 630 may be inserted through and coupled to the terminal coupling part 611 such that the outer circumferential surface of the connection member 630 can be brought in contact with an inner circumferential surface of the terminal coupling part 611.

Accordingly, the terminal member 620 surrounded by the connection member 630 may be inserted through and coupled to the terminal coupling part 611. Thus, it may be possible to prevent the parts of the terminal member 620 other than the input terminal 621 and the output terminal 622 from being electrically conductive to an external member in an arbitrary manner.

The connection member 630 may be formed of an insulating material. In an embodiment, the connection member 630 may be formed of a ceramic material.

The terminal member 620 housed in the connection member 630 may be configured to be movable in the length direction. Alternatively, the connection member 630 inserted through and coupled to the terminal coupling part 611 may be configured to be moveable in the length direction.

Thus, when the elastic member 640 is compressed or stretched, the terminal member 620 may remain connected to the inverter 300 and the motor part 400 although the support member 610 may move toward the inverter 300 or the motor part 400.

The elastic member 640 may be configured to damp vibration generated when the motor part 400 is driven such that the vibration is not transferred to the inverter 300.

The elastic member 640 may have any form capable of being compressed by the vibration of the motor part 400, storing a restoring force, returning to an original position, and canceling the vibration of the motor part 400. In an embodiment, the elastic member 640 may be provided as a coil spring.

In the shown embodiment, the terminal member 620 at the input terminal 621 side may be inserted into and coupled to the elastic member 640. Alternatively, the terminal member 620 at the output terminal 622 side may be inserted into and coupled to the elastic member 640.

Furthermore, the elastic member 640 may have a plurality of elastic members, and the terminal members 620 at both of the input terminal 621 side and the output terminal 622 side may be inserted into each of the elastic members 640.

The elastic member 640 may be located between the input terminal 621 and the connection member 630. This may be for the connection member 630 to support one side of the elastic member 640 facing the support member 610 when the elastic member 640 is compressed by the vibration of the motor part 400.

To this end, the inner diameter of the elastic member 640, that is, the diameter of the hollow portion formed inside the elastic member 640 may be smaller than the outer diameter of the connection member 630.

The elastic member 640 may be formed of any material and shape capable of storing a restoring force when the elastic member 640 is compressed or stretched. In an embodiment, the elastic member 640 may be formed of Fe—Ni 50% alloy (an iron alloy with 50% nickel content) or Cu—Ni 30% alloy (a copper alloy with 30% nickel content).

Also, the elastic member 640 may be formed of different materials along the length direction. In an embodiment, one side of the elastic member 640 facing the input terminal 621 may be formed of Cu—Ni 30% alloy, and one side of the elastic member 640 facing the support member 610 may be formed of Fe—Ni 50% alloy.

In another embodiment, one side of the elastic member 640 may be supported by the support member 610. In this case, the diameter of the hollow portion formed inside the elastic member 640 may be larger than the outer diameter of the connection member 630.

The elastic member 640 may have a plurality of elastic members. In the shown embodiment, since the terminal member 620 may have a total of three terminal members, the elastic member 640 may have a total of three elastic members, that is, a first elastic member 640a, a second elastic member 640b, and a third elastic member 640c.

The coupling relationship in which the inverter 300 and the motor part 400 are electrically connected to each other by the electrically conductive part 600 according to an embodiment of the present disclosure will be described in detail below with reference to FIGS. 7 and 9 to 11.

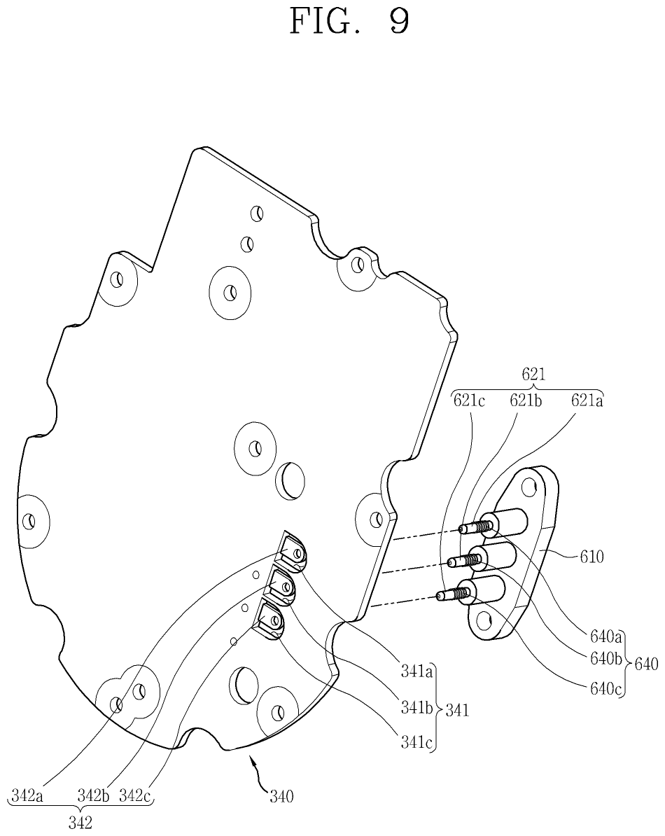

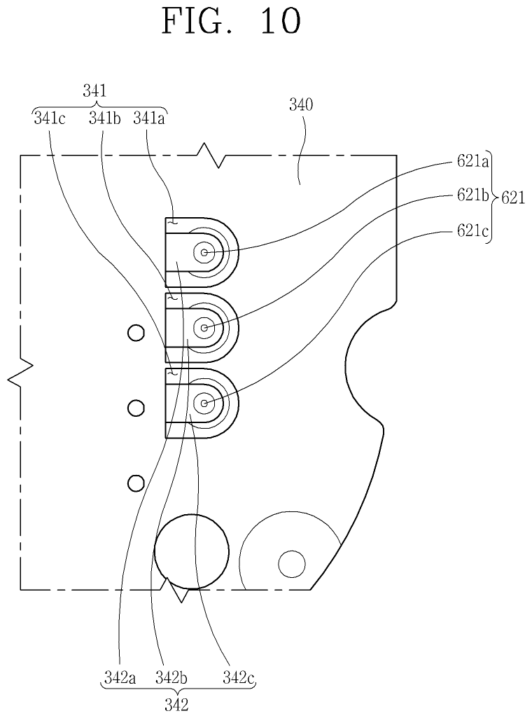

For the sake of understanding, the illustration of the inverter housing 310 is omitted in FIGS. 9 and 10.

Referring to FIGS. 7, 9, and 10, the connection relationship between the inverter 300 and the electrically conductive part 600 is shown.

The inverter chamber S1 may be formed between the inverter housing 310 and the inverter cover 320 of the inverter 300. The printed circuit board 340 and the inverter device 350 may be housed in the inverter chamber S1.

Also, the inverter bracket 343 may be provided on one side of the printed circuit board 340 facing the inverter housing 310. The printed circuit board 340 and the inverter device 350 may remain spaced a predetermined distance from the inverter housing 310 by using the inverter bracket 343.

The electrically conductive part 600 may be coupled to the connector coupling part 312 of the inverter housing 310.

In detail, the support member 610 of the electrically conductive part 600 may be inserted into and coupled to the support member insertion blind hole 312a of the connector coupling part 312. In an embodiment, the support member 610 may be fully inserted into the support member insertion blind hole 312a.

Also, the terminal member 620 of the electrically conductive part 600 may be inserted into and coupled to the input terminal insertion hole 312b of the connector coupling part 312.

When the coupling between the electrically conductive part 600 and the inverter 300 is in progress, the input terminal 621 of the terminal member 620 inserted through and coupled to the input terminal insertion hole 312b may be approaching the inverter 300.

When the approach is complete, the input terminal 621 may be brought in contact with the input terminal connection part 342. The input terminal connection part 342 may be formed of a conductive material and may be electrically connected to the printed circuit board 340 and an inverter device 350.

Accordingly, when the input terminal 621 is connected to the input terminal connection part 342, the input terminal 621 may be electrically connected to the printed circuit board 340 and the inverter device 350.

In this case, the elastic member 640 which the input terminal 621 is inserted through and coupled to may be located between the inverter housing 310 and the support member 610. This will be described in detail below.

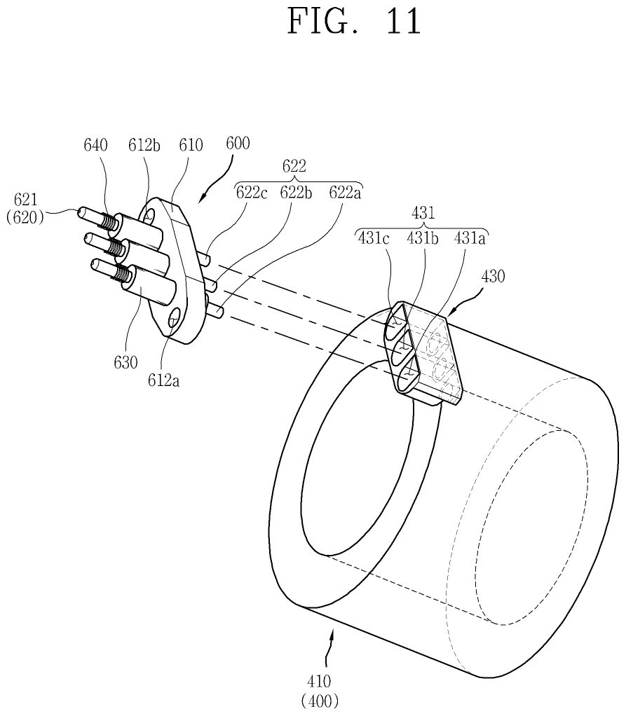

Referring to FIG. 11, the connection relationship between the motor part 400 and the electrically conductive part 600 is shown.

The output terminal housing part 430 may be provided in the motor part 400. The electrically conductive part 600 may be coupled to the output terminal housing part 430.

In detail, the output terminal 622 of the electrically conductive part 600 may be inserted into and coupled to the output terminal housing part 430. In an embodiment, the output terminal 622 may be inserted into the output terminal housing part 430 until the end of the connection member 630 is brought into contact with the output terminal housing part 430.

An electrically conductive member (not shown) for electrically connecting the stator 410 and the output terminal housing part 430 may be provided in the output terminal housing part 430. The output terminal 622 housed in the output terminal housing part 430 may be in electrically conductive contact with the electrically conductive member (not shown).

Thus, the output terminal 622 may be electrically connected to the electrically conductive member (not shown) and the stator 410. As a result, the power and control signal applied to the inverter 300 may be transferred to the stator 410 through the input terminal 621 and the output terminal 622.

Accordingly, the inverter 300 and the motor part 400 may be electrically connected to each other just by the electrically conductive part 600 being inserted into and coupled to the inverter 300 and the motor part 400. Therefore, a complicated wiring structure for electrically connecting the inverter and the motor part 400 may not be required, and thus it may be possible to simplify a wiring structure inside the electric compressor 10.

The electrically conductive part 600 according to an embodiment of the present disclosure may comprise an elastic member 640 for damping vibration generate due to the operation of the motor part 400.

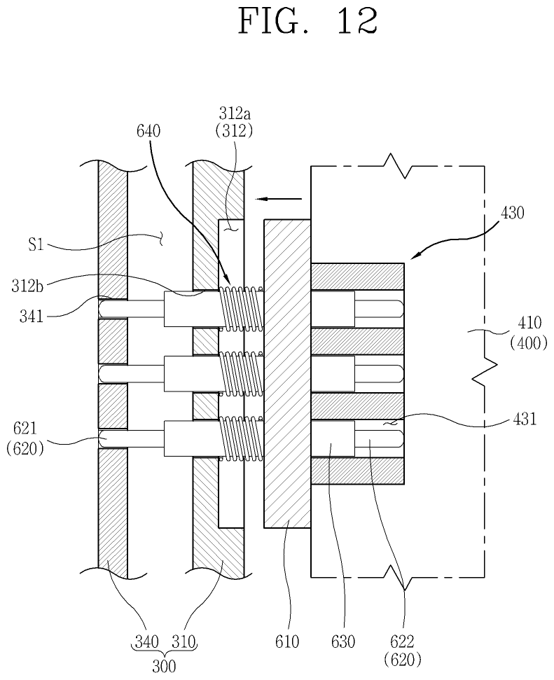

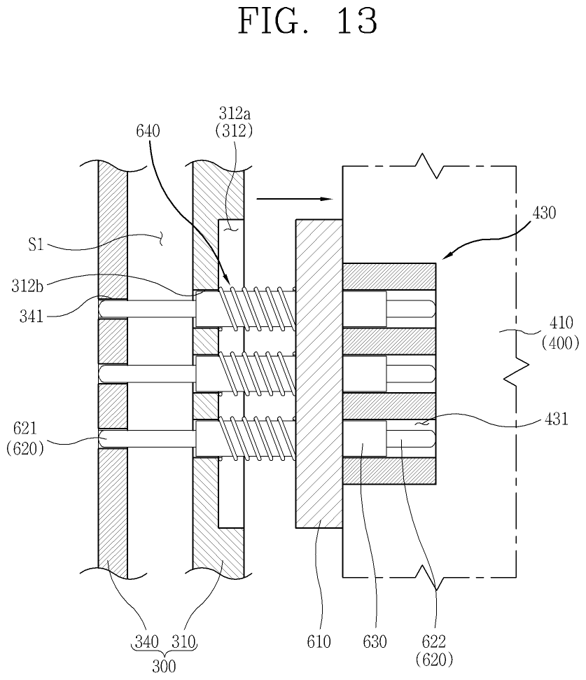

The process of damping vibration of the electric compressor 10 according to an embodiment of the present disclosure will be described in detail below with reference to FIGS. 12 and 13.

Referring to FIG. 12, it is shown that vibration may be generated in a direction facing the inverter 300 when the motor part 400 is driven.

The inverter 300 and the motor part 400 may be electrically connected to each other by the electrically conductive part 600. Accordingly, along with the vibration of the motor part 400, the electrically conductive part 600 may also be moved toward the inverter 300.

In this case, the elastic member 640 may be provided between the support member 610 of the electrically conductive part 600 and the inverter housing 310 of the inverter 300. Accordingly, when the electrically conductive part 600 is moved by the vibration of the motor part 400, the elastic member 640 may be compressed (see FIG. 12).

When the elastic member 640 is compressed, the vibration of the motor part 400 may be damped. Accordingly, the vibration of the motor part 400 may not be transferred to the inverter 300, and thus it may be possible to prevent the printed circuit board 340 and the inverter device 350, which are sensitive to shock, from being damaged by the vibration.

The vibration of the motor part 400 may be generated in a direction opposite to the inverter 300 as well as in the direction facing the inverter 300.

When the inverter 300 is moved in the direction opposite to the inverter 300 along with the vibration of the motor part 400, the electrically conductive part 600 electrically connected to the motor part 400 may also be moved in the direction opposite to the inverter 300. In this case, the elastic member 640 may be stretched along with the movement of the motor part 400 and the electrically conductive part 600.

When the elastic member 640 is stretched, the vibration of the motor part 400 may be damped. Accordingly, the vibration of the motor part 400 may not be transferred to the inverter 300, and thus it may be possible to prevent the printed circuit board 340 and the inverter device 350, which may be sensitive to shock, from being damaged by the vibration.

Furthermore, although the motor part 400 may vibrate to cause displacement, the displacement may be buffered by the elastic member 640, and thus the inverter 300 may not move. Thus, the inverter 300 may stably remain coupled to the main housing 100 and the motor part 400.

The electrically conductive part 600 may comprise the terminal member 620 formed of a conductive material. One side of the terminal member 620 facing the inverter 300 may be defined as the input terminal 621, and the other side of the terminal member 620 facing the motor part 400 may be defined as the output terminal 622. The input terminal 621 and the output terminal 622 may be inserted into and coupled to the inverter 300 and the motor part 400. Thus, the inverter 300, the motor part 400, and the electrically conductive part 600 may be electrically connected to each other.

Accordingly, it may not be necessary to provide a separate wiring, and thus it may be possible to simplify the structure for electrically connecting the inverter 300 and the motor part 400. In particular, the input terminal 621 may be fastened to the input terminal connection part 342 through a method such as soldering, and thus it may be possible to stably maintain electrical conductive states between the inverter 300, the motor part 400, and the electrically conductive part 600.

Furthermore, there may be no need for a process for connecting and fastening the wiring to the inverter 300 and the motor part 400. As a result, it may be possible to simplify a process for producing the electric compressor 10.

Also, the elastic member 640 may be provided on one side of the terminal member 620 facing the inverter 300, that is, one side adjacent to the input terminal 621. The elastic member 640 may be compressed or stretched due to vibration generated during the operation of the motor part 400 and may be configured to store a restoring force.

Accordingly, the vibration generated in the motor part 400 may be damped by the elastic member 640 and thus may not be transferred to the inverter 300. Thus, it may be possible to prevent the inverter 300 from being damaged by the vibration generated by the motor part 400.

Furthermore, although the motor part 400 and the electrically conductive part 600 connected to the motor part 400 may be moved due to the vibration of the motor part 400, the displacement may be canceled by the elastic member. Thus, it may be possible to prevent the damage of the inverter 300 that may be generated when the location of the inverter 300 is changed.

Also, the input terminal 621 of the electrically conductive part 600 may be electrically connected to the input terminal connection part 342 formed on the printed circuit board 340. Accordingly, it may not be necessary to provide a separate busbar assembly for electrically connecting the inverter 300 and the electrically conductive part 600.

Therefore, a space for housing the busbar assembly may not need to be formed inside the inverter 300, and thus it may be possible to reduce the size of the inverter 300. Also, compared to the case in which the busbar assembly is provided, it may be possible to improve the degree of freedom in placement of the printed circuit board 340 and the inverter device 350. Accordingly, the designing and producing process may be simplified.

The foregoing description has been given of the preferred embodiments, but it will be apparent to those skilled in the art that various modifications and variations can be made in the present disclosure without departing from the spirit or scope of the disclosure as defined in the appended claims.

What is claimed is:

1. An electric compressor comprising:
a motor part comprising a stator and a rotor rotatably housed in the stator;
an inverter electrically coupled to the motor part, the inverter being configured to apply a control signal to the motor part;
a compression part coupled to the motor part and configured to rotate along with a rotation of the motor part to compress refrigerant; and
an electrically conductive part configured to electrically connect the motor part and the inverter, wherein
the electrically conductive part comprises:
a support member forming a body;
a terminal member extending lengthwise, wherein the terminal member is inserted through and coupled to the support member, and wherein the terminal member is electrically coupled to the inverter; and
an elastic member provided between the support member and the terminal member facing the inverter, wherein the elastic member is compressed or stretched by vibration generated in the motor part to store a restoring force.

2. The electric compressor of claim 1, wherein the terminal member comprises:
an input terminal located in a direction facing the inverter; and
an output terminal located in a direction opposite to the input terminal and facing the motor part, wherein the output terminal is electrically coupled to the motor part.

3. The electric compressor of claim 2, wherein the input terminal and the output terminal are electrically coupled to each other.

4. The electric compressor of claim 3, wherein the electrically conductive part comprises a connection member inserted through and coupled to the support member, and wherein the connection member is configured to surround a part of the terminal member adjacent to the support member.

5. The electric compressor of claim 1, wherein,
the elastic member comprises a coil spring having a hollow portion formed therein, and
the terminal member is inserted through and coupled to the hollow portion.

6. The electric compressor of claim 2, wherein the inverter comprises:
an inverter housing forming an external side facing the motor part;
an inverter cover located on another side of the inverter housing opposite to the motor part, wherein the inverter cover is coupled to the inverter housing and configured to form an inverter chamber therein; and
a printed circuit board housed in the inverter chamber.

7. The electric compressor of claim 6, wherein the printed circuit board comprises:
an input terminal housing part formed through the printed circuit board and configured such that the input terminal is inserted to the input terminal housing part; and
an input terminal connection part provided in the input terminal housing part, wherein the input terminal connection part is brought in electrically conductive contact with the input terminal.

8. The electric compressor of claim 7, wherein the inverter housing comprises a support member insertion hole recessed a predetermined distance from one surface facing the motor part, and wherein the support member is configured to be inserted in the support member insertion hole.

9. The electric compressor of claim 7, wherein the inverter housing comprises an input terminal insertion hole formed through one surface facing the motor part, and wherein the input terminal is configured to be inserted through and coupled to the input terminal insertion hole.

10. The electric compressor of claim 9, wherein, when the electrically conductive part and the inverter are coupled to each other, the input terminal is inserted through and coupled to the input terminal insertion hole, and is inserted into and coupled to the input terminal housing part such that the input terminal is in electrically conductive contact with the input terminal connection part.

11. The electric compressor of claim 2, wherein the motor part comprises an output terminal housing part located on one side of the motor part facing the inverter, and wherein the motor part is configured to be inserted into, coupled to, and electrically connected to the output terminal.

12. The electric compressor of claim 1, wherein the elastic member is formed of two or more different materials along a length direction thereof.

13. The electric compressor of claim 12, wherein:
one side in the length direction of the elastic member adjacent to the support member is formed of a copper-nickel (Cu—Ni) alloy material, and
another side opposite to the one side in the length direction of the elastic member is formed of an iron-nickel (Fe—Ni) alloy material.

14. The electric compressor of claim 1, wherein the terminal member is formed of an iron-nickel alloy material.

15. The electric compressor of claim 4, wherein the connection member is formed of a ceramic material.
